(19) United States
(12) Patent Application Publication
(10) Pub. No.: US 2015/0251598 A1
(43) Pub. Date: Sep. 10, 2015

(54) Vehicle Hazard Light Strip

(71) Applicant: Errol Andrews, Tampa, FL (US)

(72) Inventor: Errol Andrews, Tampa, FL (US)

(21) Appl. No.: 14/195,892

(22) Filed: Mar. 4, 2014

(51) Int. Cl. B60Q 7/00; F21S 9/02; F21V 21/096; F21S 4/00; F21V 23/02

(52) U.S. Cl. CPC B60Q 7/00; F21S 4/008; F21V 23/02; F21V 21/096; F21S 9/024

(57) ABSTRACT

Disclosed is an LED light strip for use as a vehicle hazard light system, comprising one or more clusters of LEDs, a control circuit, a power adapter, and a support. The clusters of LEDs comprise a plurality of individual LEDs. Some clusters of LEDs are white in order to provide light, while others are red to serve as warning lights for oncoming vehicles. The clusters of LEDs are disposed on the support and are electrically connected to one another by a control circuit. The control circuit connects the clusters of LEDs to a power adapter designed to plug into a vehicle's power outlet. The LED light strip may further have means for electrically connecting to a rechargeable battery. When a motorist is pulled over with a disabled vehicle, the LED light strip provides ample light for the motorist to make repairs while alerting oncoming traffic to the motorist's presence.

### FIELD OF THE INVENTION

The present invention relates to vehicle emergency lighting. More specifically, the present invention describes a vehicle hazard light strip comprising a plurality of clusters of LEDs that is capable of providing light for the user and that alerts approaching vehicles to the user's location.

Motorists with car troubles often have to pull their disabled vehicles off to the side of the road in order to make repairs, inspect the vehicle, or call for help. While car troubles are inconvenient for the user, the user's problems are magnified when the car troubles occur at night. It can be dangerous for motorists to pull a disabled vehicle onto the side of the road at night and then exit the vehicle to inspect it and make repairs. A motorist may exit the vehicle to look for a flat tire, to open the trunk of the car and retrieve tools therefrom, or to open the hood of the car to examine the internal parts of the car. Oncoming cars may have difficulty seeing the motorist and the motorist's disabled vehicle, and thus the motorist is exposed to the risk of being struck by an oncoming car. In addition to exposure to the risk of being struck by an oncoming vehicle, the low light conditions may also make it difficult for a user to properly inspect a vehicle for problems and to make the necessary repairs.

Motorists pulled over onto the side of the road will often use the vehicle's hazard lights, or four-way-flashers, to alert oncoming traffic to the motorist's presence. However, oncoming vehicles may still have trouble seeing the hazard lights at night. Additionally, the hazard lights do not provide sufficient light for a motorist to inspect their vehicle or make repairs to their vehicle. Alternatively, a motorist may choose to use a flashlight to inspect the vehicle and make repairs, however the flashlight may not provide sufficient light to illuminate a large area. The motorist may also find it difficult to make repairs or change a tire while having to hold the flashlight.

The present invention describes an LED light strip for use as a vehicle hazard light system. The invention describes a plurality of clusters of LEDs, wherein some clusters of LED lights are red and others are white. The red LEDs serve to alert oncoming vehicles to the motorist's presence, while the white LEDs provide sufficient light for the motorist to make repairs and inspect their vehicle. The clusters of LEDs are arranged on a support, such as a fabric or rubber strip. The LEDs are connected to one another by a control circuit, which includes a power adapter suited to be plugged into a power outlet on the dashboard of a vehicle. In some embodiments of the present invention, the control circuit and the LEDs may be powered by an external battery or other power source rather than by engaging the power adapter to a vehicle's power outlet.

Devices have been disclosed in the prior art that relate to vehicle hazard lights or signals. These include devices that have been patented and published in patent application publications. These devices generally relate to emergency signaling devices for automobiles. The following is a list of devices deemed most relevant to the present disclosure, which are herein described for the purposes of highlighting and differentiating the unique aspects of the present invention, and further highlighting the drawbacks existing in the prior art.

One such prior art device is disclosed in U.S. Pat. No. 4,903,174 to Busby entitled “Vehicle Emergency Light Kit.” Busby discloses an emergency rear light kit for installation on the back of a vehicle. In operation, the user attaches the lights to the back of the vehicle, and the kit includes a control box that the user operates from inside of the vehicle. The control box plugs into a socket inside the vehicle and has switches for left and right indications, brake lights, and tail lights. The present invention does not require the user to operate a control box, nor does the present invention provide switches that can be operated to illuminate a particular light or series of lights. The device in Busby does not provide a motorist with sufficient light to make repairs to a disabled vehicle and is instead intended only as a replacement for disabled rear vehicle lights.

U.S. Pat. No. 7,388,514 to McDow discloses an emergency light assembly comprising a panel on which several lights are arranged in the shape of an arrow, wherein a first arrow points left and a second arrow points right. A control is coupled to the lights for selectively turning the lights on and off. The lights may be powered by batteries or by means of a male vehicle power plug. McDow discloses lights for use on a disabled vehicle in the shape of an arrow so as to signal which direction oncoming vehicles should travel in order to avoid the disabled vehicle. McDow does not disclose emergency lights that are capable of providing light to a user making repairs to a disabled vehicle.

U.S. Pat. No. 5,797,672 to Dobert entitled “Safety Light” discloses a battery powered replacement light for a vehicle's tail light. The device may further include a stand that enables the device to serve as an emergency marker light. The device comprises an array of LEDs connected together on a circuit board. The device attaches to a vehicle by means of magnets. The device in Dobert comprises a single light composed of a series of LEDs, and does not disclose an emergency light adapted for use as a light source.

U.S. Pat. No. 2,905,925 to Whiteneck entitled “Warning Light for Attaching to an Automobile” discloses a safety light capable of being mounted on a motor vehicle. The device comprises a lamp having a plurality of suction cups for attachment to a surface of a motor vehicle. The lamp is powered by means of a plug that fits into the cigarette lighter of the motor vehicle. Whiteneck discloses a single light for mounting on a vehicle as a warning light, and does not disclose a plurality of clusters of LED lights suitable for use as a light source.

U.S. Pat. No. 6,549,121 to Povey et al. entitled “Illuminated Emergency Signaling Device” discloses a signaling device powered by means of a battery pack and having a pulsating light means. A race is disposed around the periphery of the cover of the signaling device for reflecting light from the light means, which may be one or more LEDs. The device disclosed by Povey et al. serves as a beacon or signaling device to warn passers-by of an emergency situation and to aid emergency personnel in identifying the location of the emergency. Thus, Povey et al. does not disclose a light source sufficient to illuminate an area or that can provide sufficient light for a user to make repairs to a vehicle.

U.S. Pat. No. 6,848,808 to Guerrieri entitled “Combination Fastener and Light Device” discloses a combination fastener and lighting device for the purpose of illuminating the interior of a carrying case when the members of the fastener are separated, such as when the case is open. Thus, Guerrieri discloses a light source for illuminating the inside of a case or purse and does not disclose a light source sufficient to illuminate a larger area. Further Guerrieri does not disclose a warning light system adapted for use with automobiles.

U.S. Pat. No. 5,438,490 to Woodbury entitled “Light Mount for Vehicle Being Towed” discloses a device comprising signal lights adapted to be placed on the back of a vehicle being towed by another vehicle. The device includes several units each having a thin mounting plate and carrying a signal light, wherein the mounting plate can be wedged into the gaps between body panels of the vehicle. Woodbury discloses a series of signal lights to serve as warning lights for other vehicles, but does not disclose an illumination source suited to provide light for performing repairs on a vehicle or for inspecting a vehicle.

U.S. Patent Publication Number 2003/0160690 to Baldwin entitled “Magnetically Mountable Vehicle Hazard Device” discloses a magnetically mountable and portable vehicle hazard light for the purpose of warning other motorists or assisting emergency response or roadside assistance in locating the disabled vehicle. Further, Baldwin discloses the device as being battery powered or powered by a connection to the vehicle's cigarette lighter. Baldwin discloses a hazard light that can be mounted on a vehicle using magnets, but does not disclose a device capable of providing light for a user, nor does Baldwin disclose a series of lights.

Finally, U.S. Patent Publication Number 2003/0169164 to Lau entitled “Signaling Device” discloses an array of lights mounted on a case wherein a controller is coupled to the lights. The controller is capable of illuminating the lights in a sequential pattern to provide an appearance of movement in a predetermined portion of the array of lights. Lau discloses a device suitable for providing a warning for a disabled motor vehicle, but does not disclose a lighting system capable of providing a motorist with enough light to make repairs to a disabled vehicle.

These prior art devices have several known drawbacks. The devices disclosed in the prior art describe signal lights designed to attach to vehicles in a variety of ways. Further, the signal lights in the prior art disclose lights arranged in a variety of shapes and designs. However, the prior art does not disclose a combination of a signal light and additional lights sufficient to illuminate a larger area. The signal lights disclosed in the prior art serve the purpose of alerting passers-by or emergency personnel to the location of a disabled vehicle and are not intended to be used as a source of light. Additionally, several devices in the prior art disclose the use of a single light or signal and do not disclose a series of lights or signals.

In light of the devices disclosed in the prior art, it is submitted that the present invention substantially diverges in design elements from the prior art and consequently it is clear that there is a need in the art for an improvement to existing vehicle hazard light devices. In this regard the instant invention substantially fulfills these needs.

### SUMMARY OF THE INVENTION

In view of the foregoing disadvantages inherent in the known types of vehicle hazard lights now present in the prior art, the present invention provides a new LED light strip for use as a vehicle hazard light system wherein the same can be utilized for providing convenience for the user when the user's vehicle is disabled and is pulled over on the side of a dark road.

It is therefore an object of the present invention to provide a new and improved vehicle hazard light system that has all of the advantages of the prior art and none of the disadvantages.

It is another object of the present invention to provide a vehicle hazard light strip capable of providing sufficient light for a user to make repairs to a disabled vehicle at night.

Another object of the present invention is to provide a vehicle hazard light strip equipped with red warning lights to alert oncoming vehicles to the user's presence.

Yet another object of the present invention is to provide a vehicle hazard light strip having a convenient means for powering the light strip and that can either be powered by a battery or plugged into a vehicle's power outlet.

Another object of the invention is to provide the user with a vehicle hazard light strip that may easily be stored in a user's vehicle, and that can be easily deployed when the light strip is needed.

Another object of the invention is to provide the user with a vehicle hazard light strip that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a top down view of the preferred embodiment of the light strip of the present invention.

FIG. 2 shows a close-up view of a cluster of LEDs.

FIG. 3 shows a working view of an embodiment of the vehicle hazard light strip placed adjacent to a disabled vehicle.

FIG. 4 shows a working view of the light strip of the present invention placed on the underside of the hood of a disabled car for illuminating the area under the hood of the vehicle.

### DETAILED DESCRIPTION OF THE INVENTION

Reference is made herein to the attached drawings. Like reference numerals are used throughout the drawings to depict like or similar elements of the vehicle hazard light strip. For the purposes of presenting a brief and clear description of the present invention, the preferred embodiment will be discussed as used for assisting a motorist who is pulled over on the side of a dark road with a disabled vehicle. The figures are intended for representative purposes only and should not be considered to be limiting in any respect.

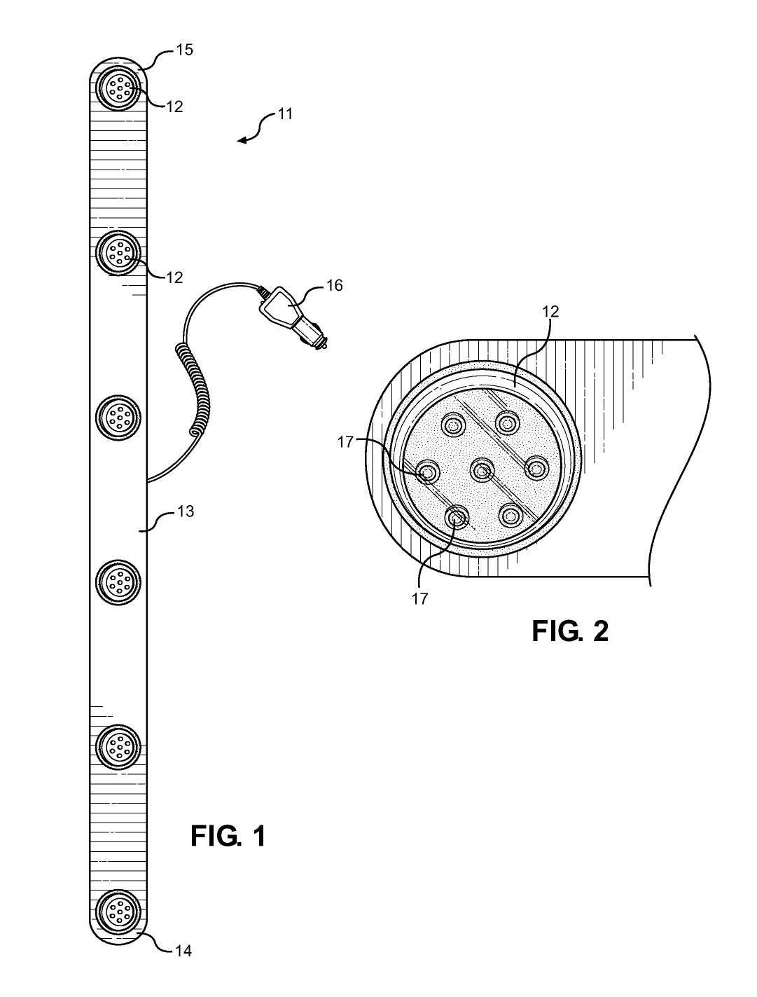

Referring now to FIG. 1, there is shown a top view of the preferred embodiment of the vehicle hazard light strip of the present invention. The light strip 11 is shown as having one or more clusters 12 of LEDs. In the embodiment shown, the clusters 12 are arranged on a support 13 having a first end 14 and a second end 15. However, other embodiments of the present invention include a support having alternative shapes, such as an L-shape for illuminating the back and the side of a vehicle. The support may be composed of fabric, rubber, or any other flexible material. In this way, the flexible support may be rolled up for storage and unrolled for use. The support is lightweight and can easily be moved by the user to any desired location.

In the embodiment of the invention shown in FIG. 1, the clusters 12 are arranged on the support in a straight line. Further, in the preferred embodiment of the invention, the cluster 12 nearest the first end 14 is red, and the cluster 12 nearest the second end 15 is red. All other clusters 12 in between are white. In this way, the red clusters help to demarcate the location of the vehicle and serve as warning lights for oncoming vehicles. The white lights serve as a source of light for the motorist, enabling the motorist to inspect the disabled vehicle, or makes repairs thereto.

A control circuit electrically connects the clusters 12 to one another and also to a power adapter 16. The control circuit is disposed on the support 13. The power adapter 16 is capable of plugging into the power outlet inside of a vehicle. In a preferred embodiment of the present invention, the power adapter is a 12-volt power adapter. The power adapter may further include an on-off switch allowing the user to turn the LEDs on the vehicle hazard light strip on or off.

The control circuit may include a variety of additional circuit components in order to increase the reliability and safety of the vehicle hazard light strip of the present invention and to minimize the risk of failure of the light strip. The control circuit may include current limiting resistors that prevent failure of the LEDs. The control circuit may include a DC to DC converter that increases the voltage provided by the power supply to provide sufficient voltage for all of the LEDs in the LED light strip. Additional circuit components that may improve the reliability and safety of the control circuit include an overvoltage protection device and a device that protects against overcurrent faults.

While the vehicle hazard light strip of the present invention includes a power adapter that can plug into a vehicle's power outlet, additional embodiments of the present invention may include means for electrically connecting to alternative power sources. Some embodiments of the present invention have attachments for electrically connecting to a rechargeable battery external to the disabled vehicle. This allows a user to utilize the vehicle hazard light strip of the present invention when the vehicle's battery is dead and is unable to power the vehicle hazard light strip. Alternatively, other embodiments of the present invention have an adapter allowing for electrical connection of the vehicle hazard light strip to a 120 volt power source. In this way, a user may use the vehicle hazard light strip of the present invention by powering the light strip with electricity from a household power source.

Referring now to FIG. 2, there is shown a close-up view of a cluster of LEDs. The cluster 12 is composed of a plurality of individual LEDs 17. In the embodiment shown in FIG. 2, the LEDs are arranged in the shape of a hexagon with an additional LED in the middle of said hexagon. Various other arrangements of the individual LEDs within a cluster are contemplated. For example, the LEDs in the cluster may be arranged in the shape of a circle or square. Further, any number of LEDs may be arranged within a cluster.

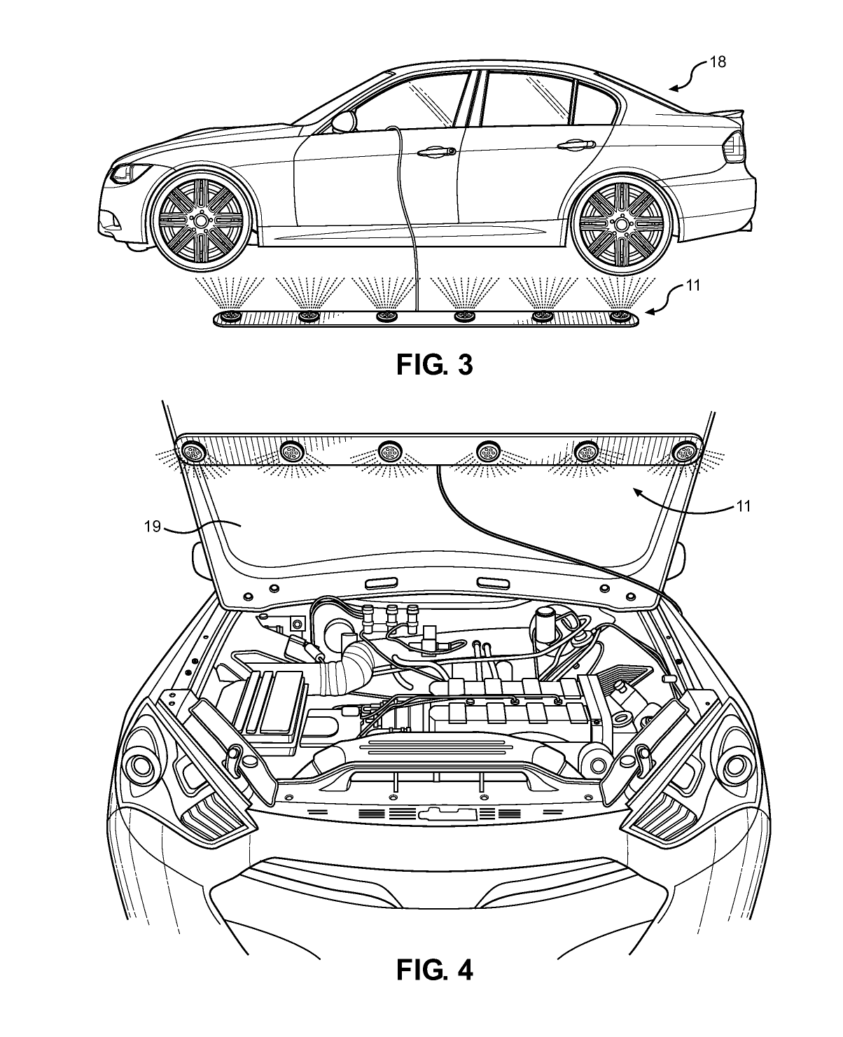

Referring now to FIG. 3, there is shown a working view of an embodiment of the vehicle hazard light strip placed adjacent to a disabled vehicle. The light strip 11 can be placed by the user adjacent to the disabled vehicle 18 so as to illuminate the length of the vehicle. In some embodiments of the present invention the total wattage of an LED cluster is between five and twenty watts. If the total wattage of the LED cluster is approximately ten watts, then the LED cluster is adapted to shed a similar amount of light as a sixty watt incandescent bulb. The wattage and characteristics of the LEDs in the cluster are selected such that the LED clusters are sufficiently bright to illuminate a portion of the disabled vehicle. The number of LEDs required to illuminate an area depends upon the wattage of the LEDs in the cluster and the specific type or quality of LED. While the white lights provide illumination of the vehicle and surrounding area, the red lights in the strip serve to warn and alert oncoming vehicles to the location of the disabled vehicle. The power adapter of the light strip can be plugged into the power outlet inside of the disabled vehicle. The user may relocate the light strip as needed to provide light to the portion of the vehicle that needs to be repaired or inspected.

Referring now to FIG. 4, there is shown a working view of the light strip of the present invention placed on the underside of the hood of a disabled car for illuminating the area under the hood of the vehicle. The light strip 11 may further comprise one or more magnets disposed on the support, on the opposite surface from the surface supporting the LED clusters, such that the light strip can be attached to the hood 19 or other metal portion of the car. In this way, the light strip may illuminate the area of the car under the hood, enabling the user to inspect the engine and adjacent areas, while simultaneously providing a warning for oncoming motorists.

Motorists dealing with car troubles often pull off to the side of the road to inspect their car and make repairs. This situation can become dangerous when the car troubles occur at night. The motorist must exit their car in order to make the required repairs and to identify his or her vehicle's problem. A vehicle's built-in hazard lights may not provide sufficient warning to oncoming cars in order to alert the oncoming cars of the user's presence. Further, the hazard lights do not provide sufficient light for the motorist to inspect or repair the disabled vehicle.

The present invention discloses a strip of LED lights for use as a hazard light system. The vehicle hazard light strip comprises one or more clusters of LEDs arranged on a support and electrically connected to one another. Further, the LEDs are connected to one another by a control circuit, which further comprises a power adapter suited to be plugged into a vehicle's power outlet. Some embodiments of the present invention further include means for electrically connecting the light strip to a rechargeable battery or a 120 volt power source, such that the light strip may be powered by a variety of power sources. The present invention provides a motorist with a disabled vehicle a convenient light source and warning light system that can be easily stored and deployed when needed.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A vehicle hazard light strip comprising:
a power adapter adapted to connect to an electrical power outlet in a vehicle;
at least one cluster of LEDs wherein said at least one cluster comprises a plurality of individual LEDs;
a control circuit electrically connecting said power adapter and said at least one cluster of LEDs;
a support on which said at least one cluster of LEDs and said control circuit are disposed.

2. The vehicle hazard light strip of claim 1, wherein said at least one cluster of LEDs is arranged in a straight line.

3. The vehicle hazard light strip of claim 2, wherein said straight line has a first end and second end, and wherein the cluster at said first end is red, the cluster at said second end is red, and wherein the clusters in between said first and second end are white.

4. The vehicle hazard light strip of claim 1, wherein said plurality of individual LEDs are arranged in a circle.

5. The vehicle hazard light strip of claim 1, wherein said plurality of individual LEDs are arranged in a hexagon.

6. The vehicle hazard light strip of claim 1, wherein said support is composed of fabric.

7. The vehicle hazard light strip of claim 1, wherein said support is composed of rubber.

8. The vehicle hazard light strip of claim 1, wherein said support further comprises a plurality of magnets adapted to attach to a metal surface of a vehicle.

9. The vehicle hazard light strip of claim 1, wherein said power adapter is adapted to connect to a 12-Volt DC power outlet.

10. The vehicle hazard light strip of claim 1, wherein said power adapter further comprises an on-off switch.

11. The vehicle hazard light strip of claim 1, wherein said control circuit comprises one current limiting resistor for each of said plurality of individual LEDs.

12. The vehicle hazard light strip of claim 1, wherein said control circuit comprises a DC to DC power converter.

13. The vehicle hazard light strip of claim 1, wherein said control circuit comprises an overvoltage protection device.

14. The vehicle hazard light strip of claim 1, wherein said control circuit comprises a device that protects against overcurrent faults.

15. The vehicle hazard light strip of claim 1, wherein the total wattage of each of said at least one cluster of LEDs is approximately ten watts.

16. The vehicle hazard light strip of claim 1, further comprising an attachment adapted to electrically connect said control circuit and said at least one cluster of LEDs to a rechargeable battery.

17. The vehicle hazard light strip of claim 1, further comprising an adapter adapted to electrically connect said control circuit and said at least one cluster of LEDs to a 120 volt power source.
